(19) United States
(12) Patent Application Publication
(10) Pub. No.: US 2015/0199894 A1
(43) Pub. Date: Jul. 16, 2015

(54) SECURITY SYSTEM AND METHOD OF PROVIDING SECURITY SERVICE BY USING THE SAME

(71) Applicant: Samsung Electronics Co., Ltd., Gyeonggi-do (KR)

(72) Inventors: Paul BRAUN, Seoul (KR); Jennifer J. Kim, San Francisco, CA (US); Ek Gregory, Seoul (KR); Sang Ho Lee, Emeryville, CA (US)

(73) Assignee: Samsung Electronics Co., Ltd.

(21) Appl. No.: 14/596,499

(22) Filed: Jan. 14, 2015

(30) Foreign Application Priority Data
Jan. 14, 2014 (KR) 10-2014-0004735

(51) Int. Cl. G08B 25/01; G08B 25/10

(52) U.S. Cl. CPC G08B 25/016; G08B 25/10

(57) ABSTRACT

A security system and a method of providing a security service are provided. The method includes receiving, by a mobile terminal, sensor data from a plurality of sensors included in a first plug-in type sensor module; integrating, by the mobile terminal, the sensor data based on a correlation between pieces of sensor data of the plurality of sensors to generate integrated information; analyzing, based on the integration information, a security situation of a place into which the first plug-in type sensor module is plugged; and providing, by the mobile terminal, a result of the analysis to a user.

### PRIORITY

This application claims priority under 35 U.S.C. §119(a) to Korean Patent Application No. 10-2014-0004735, filed in the Korean Intellectual Property Office On Jan. 14, 2014, the entire content of which is incorporated herein by reference.

### BACKGROUND OF THE INVENTION

1. Field of the Invention

The present invention relates to generally to a security service, and more particularly, to a security system and a method of providing a security service by using the same.

2. Description of the Related Art

Due to the recently increasing interest in security, many types of security systems are being provided. However, installation and relocation of conventional security systems is difficult and expensive.

### SUMMARY OF THE INVENTION

The invention has been made to address at least the above problems and/or disadvantages and to provide at least the advantages described below. Accordingly, an aspect of the present invention provides a security system and a method of providing a security service by using the same. Another aspect of the present invention is to provide a computer-readable recording medium having a program to execute the method with a computer.

According to an aspect of the present invention, a security system is provided. The security system includes a first plug-in type sensor module including a plurality of sensors; and a first mobile terminal configured to receive sensor data from the plurality of sensors included in the first plug-in type sensor module, integrate the sensor data based on a correlation between sensor data of the plurality of sensors to generate integrated information, analyze, based on the integrated information, a security situation of a place into which the first plug-in type sensor module is plugged, and provide a result of the analysis to a user.

According to another aspect of the present invention, a method of providing a security service is provided. The method includes receiving, by a mobile terminal, sensor data from a plurality of sensors included in a first plug-in type sensor module; integrating, by the mobile terminal, the sensor data based on a correlation between pieces of sensor data of the plurality of sensors to generate integrated information; analyzing, based on the integration information, a security situation of a place into which the first plug-in type sensor module is plugged; and providing, by the mobile terminal, a result of the analysis to a user.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a security system according to an embodiment of the present invention;

FIG. 2 is a diagram illustrating a sensor module according to an embodiment of the present invention;

FIG. 3 is a diagram illustrating a security system environment according to an embodiment of the present invention;

FIGS. 4A and 4B are diagrams illustrating a security system environment according to an embodiment of the present invention;

FIGS. 5A to 5C are diagrams illustrating examples of screens displayed by a mobile terminal while monitoring security situations according to an embodiment of the present invention;

FIGS. 6A to 6C are diagrams illustrating examples of screens displayed by a mobile terminal when abnormal situations occur according to an embodiment of the present invention;

FIGS. 7A to 7C are diagrams illustrating screens setting a sensor module with a mobile terminal according to an embodiment of the present invention;

FIG. 8 is diagram illustrating an example of a screen displayed by a mobile terminal when a break-in occurs according to an embodiment of the present invention; and

FIG. 9 is a flowchart illustrating a method of providing a security service according to an embodiment of the present invention.

### DESCRIPTION OF EMBODIMENTS OF THE PRESENT INVENTION

Various embodiments of the present invention are described below in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Also, in the following description, terms such as first, second, A, B, (a) and (b) may be used to distinguish one component from another and without limiting the nature or sequence of corresponding components. When a component is described as “connected” or “coupled” to another component, the former may be directly connected to the latter, but other components may also be “connected” or “coupled” therebetween.

Also, some components in the drawings may be exaggerated, left out or schematically shown. The size of each component does not accurately reflect its actual size and thus, the descriptions provided herein are not limited by the relative size or distance between components shown in the drawings.

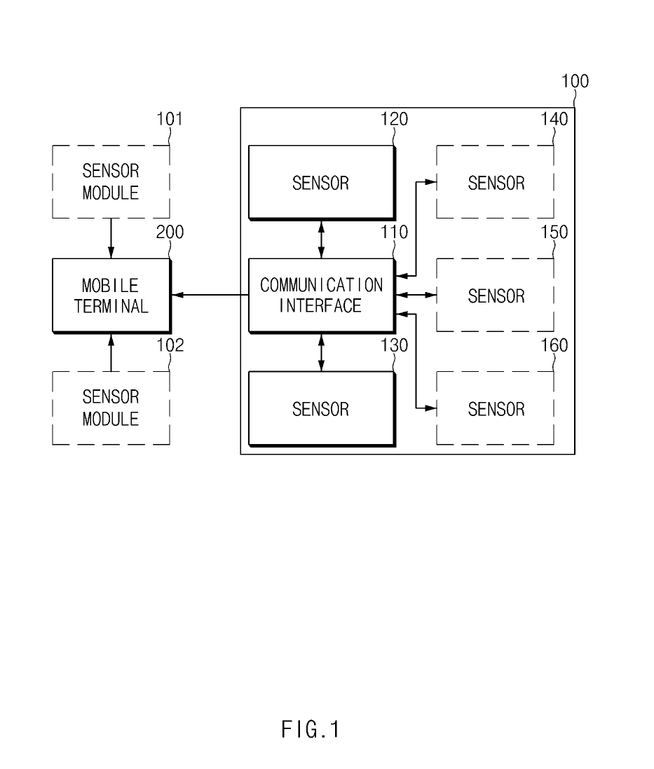

FIG. 1 is a block diagram illustrating a security system according to an embodiment of the present invention.

Referring to FIG. 1, a security system according to an embodiment of the present invention includes a mobile terminal 200 and a sensor module 100. Additional sensor modules, such as sensor modules 101 and 102 may also be included in the security system, in accordance with embodiments of the present invention. Although FIG. 1 shows only one mobile terminal 200, embodiments of the present invention are not limited thereto and a plurality of mobile terminals 200 may be connected to a plurality of sensor modules 100 in accordance with embodiments of the present invention.

The sensor module 100 is a sensor device that includes a plurality of sensors (i.e., sensors 120 and 130). The sensor module 100 communicates with the mobile terminal 200 in a security system and transmits sensor data from the plurality of sensors 120 and 130 to the mobile terminal 200.

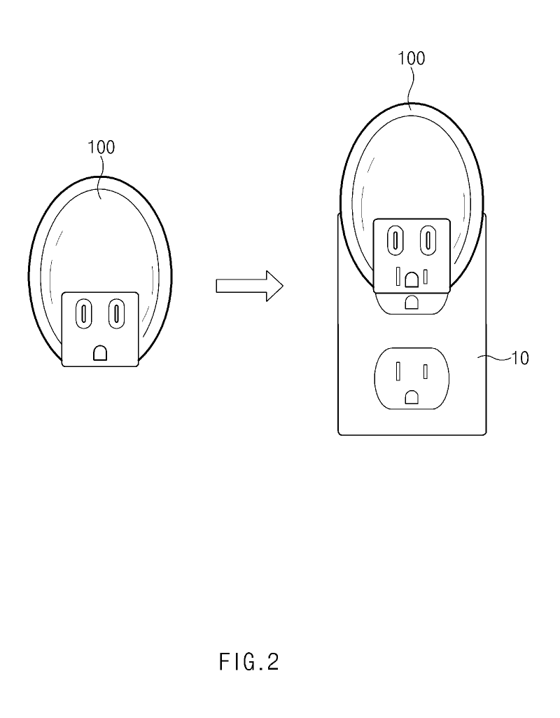

According to an embodiment of the present invention, the sensor module 100 is a plug-in type sensor module, which means that the sensor module 100 can be plugged into a wall socket to be operated. A detailed description of the plug-in type of sensor module is provided herein below with reference to FIG. 2.

Referring back to FIG. 1, the sensor module 100 includes a plurality of sensors 120 and 130 and a communication interface 110. However, the sensor module 100 is not limited to only two sensors, and additional sensors, such as sensors 140, 150, and 160, may also be included in the sensor module 100 in accordance with embodiments of the present invention.

The plurality of sensors 120 and 130 include at least one of a motion sensor, a microphone sensor, a temperature sensor, an illumination sensor and a carbon monoxide (CO) sensor. However, embodiments of the present invention are not limited thereto and the sensor module 100 may include various other types of sensors that assist in analyzing a security situation.

Although the example of FIG. 1 shows that the sensor module 100 may include two to five sensors, embodiments of the present invention are not limited thereto, and more than five sensors may be used in accordance with embodiments of the present invention.

The sensor module 100 transmits sensor data obtained from the plurality of sensors 120 and 130 to the mobile terminal 200 through the communication interface 110.

The communication interface 110 transmits and receives data through a wired or wireless network or a wired serial communication. Examples of such a network include the Internet, a Local Area Network (LAN), a Wireless LAN (WLAN), a Wide Area Network (WAN), and a Personal Area Network (PAN), but embodiments of the present invention are not limited thereto. Accordingly, the network may include other types of networks that for transmitting and receiving information.

The communication interface 110 provides short-range wireless communication. Thus, the sensor module 100 may be executed through short-range wireless communication with the mobile terminal 200. The short-range communication technologies according to embodiments of the present invention may include, but are not limited to Bluetooth, Radio Frequency IDentification (RFID), Infrared Data Association (IrDA), Ultra WideBand (UWB), ZigBee, and Wi-Fi Direct (WFD), and Near Field Communication (NFC).

The mobile terminal 200 receives sensor data from the plurality of sensors 120 and 130 of a first sensor module 100. The mobile terminal 200 integrates sensor data based on the correlation between pieces of sensor data of the plurality of sensors 120 and 130 and analyzes security situation of a location where the first sensor module 100 is plugged-in based on the integrated information.

The correlation between pieces of sensor data represents the analysis of a piece of sensor data in association with another piece of sensor data. For example, when sound is sensed through a microphone sensor, but there is no motion from a motion sensor, the mobile terminal 200 may determine that there is a break-in attempt. As such, the mobile terminal 200, according to embodiments of the present invention may integrate at least two pieces of sensor data associated with each other and analyze the security situation of a place where the sensor module 100 is installed, based on the integrated information.

According to an embodiment of the present invention, the mobile terminal 200 also obtain information regarding the location of the mobile terminal 200. The mobile terminal 200 analyzes a security situation by using the obtained information regarding the location of the mobile terminal 200. For example, by using information on the location of the mobile terminal 200, the mobile terminal 200 may sense at least one of a motion and a sound from a place through a motion sensor and a microphone sensor of the sensor module 100 even if a user is not at the place where the sensor module 100 is installed. Based on such integrated information, the mobile terminal 200 may analyze whether the place the sensor module 100 is located has a trespasser.

According to an embodiment of the present invention, the mobile terminal 200 may further obtain the place related characteristics of the place. The mobile terminal 200 analyzes a security situation by using the place-related characteristics in addition to the information described herein above. For example, if the place-related characteristic of the place is not a cooking place such as a kitchen, the mobile terminal 200 may sense through a temperature sensor or a CO sensor of the sensor module 100, that at least one of a temperature and the concentration of CO is at least equal to a certain threshold value. For example, based on such integrated information, the mobile terminal 200 may determine that a fire has occurred in the place according to results of the analysis.

According to another embodiment of the present invention, the mobile terminal 200 also obtains behavior information of a user. The mobile terminal 200 analyzes a security situation by additionally using the obtained behavior information. For example, even if the behavior information of the user indicates a sleeping state, the mobile terminal 200 may also sense (e.g., through a motion sensor or a microphone sensor of the sensor module 100) that there is at least one of a motion and a sound at the location of the sensors. Based on such integrated information, the mobile terminal 200 may determine that there is a trespasser.

According to another embodiment of the present invention, a security system may use at least two modules to analyze a security situation. For convenience, the at least two sensor modules are described herein below with reference to a first sensor module 100 and a second sensor module 101.

The place may include a first space and a second space. The security system may locate the first sensor module 100 and the second sensor module 101 having the same form as the first sensor module 100 in a first space and a second space, respectively, within a same location.

For example, when the security system is installed in a home, the first sensor module 100 and the second sensor module 101 may be installed in a living room and a hallway, respectively.

According to another embodiment of the present invention, the mobile terminal 200 receives sensor data from a plurality of sensors of each of the first sensor module 100 and the second sensor module 101. The mobile terminal 200 integrates the sensor data based on the spatial correlation between pieces of sensor data of the plurality of sensors and analyzes the security situation of the location of the sensor modules based on integrated information.

According to another embodiment of the present invention, the mobile terminal 200 obtains path characteristics between the first space and the second space related to entry and exit and movement in the place. The mobile terminal 200 analyzes a security situation by additionally using the path characteristics.

For example, even if a motion corresponding to an entry into the location starts in the first space due to the first space being near the entrance of the location, the mobile terminal 200 senses through a motion sensor of the second sensor module 101 that there is motion in the second space occurring prior to the motion in the first space. Based on this integrated information, the mobile terminal 200 determine that the location of the motion in the place is abnormal in light of the path characteristics of the place (in contrast to normal motion originating from the first space near the entrance of the location). Thus, the mobile terminal 200 determines that the location has a trespasser by analyzing the sensor information.

The mobile terminal 200 provides a result of the analysis result to a user.

According to an embodiment of the present invention, the mobile terminal 200 provides a push notification alerting and informing a user that an abnormal situation has occurred.

According to an embodiment of the present invention, the mobile terminal 200 provides the details of sensor data if, upon a determination that an abnormal situation has occurred.

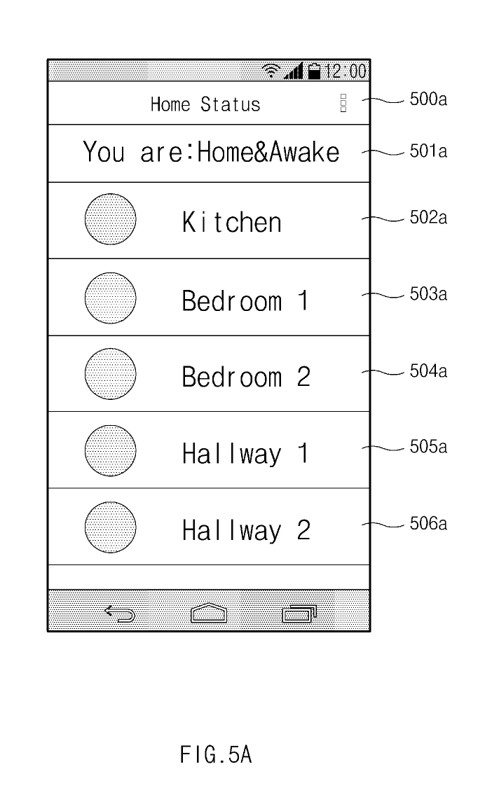

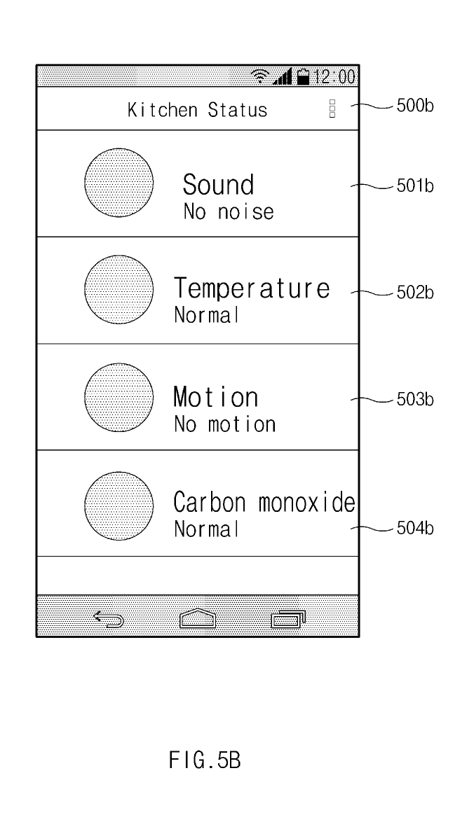

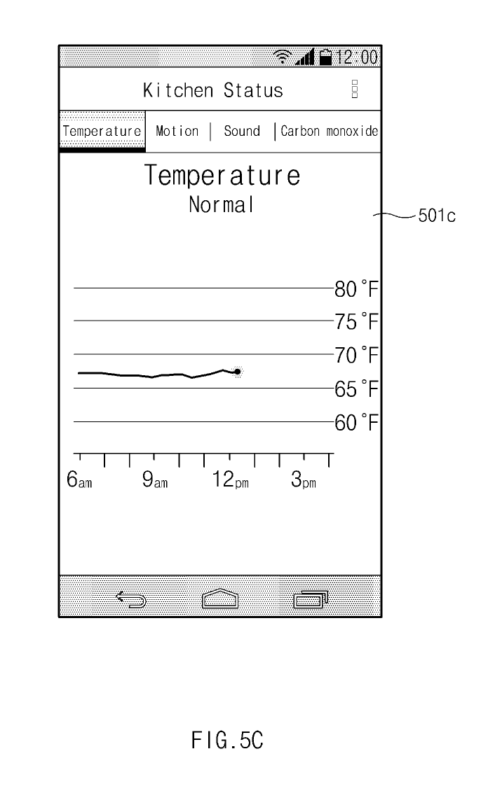

In this present example, the mobile terminal 200 provides monitoring of a security situation for each space in which the first sensor module 100 and the at least one sensor module 101 and 102 are respectively located. The mobile terminal 200 also provides monitoring of sensor data for each sensor of each of the first sensor module 100 and the at least one sensor module 101 and 102. A further detailed description of this monitoring is provided herein with reference to FIGS. 5A to 5C.

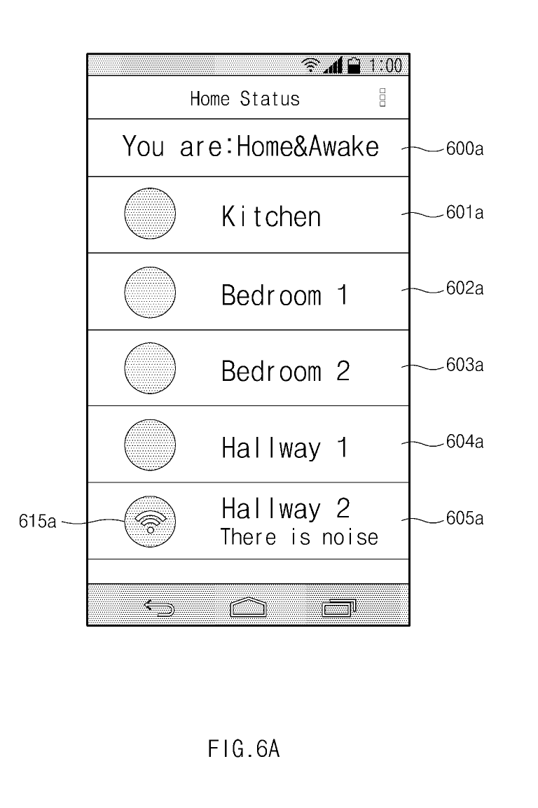

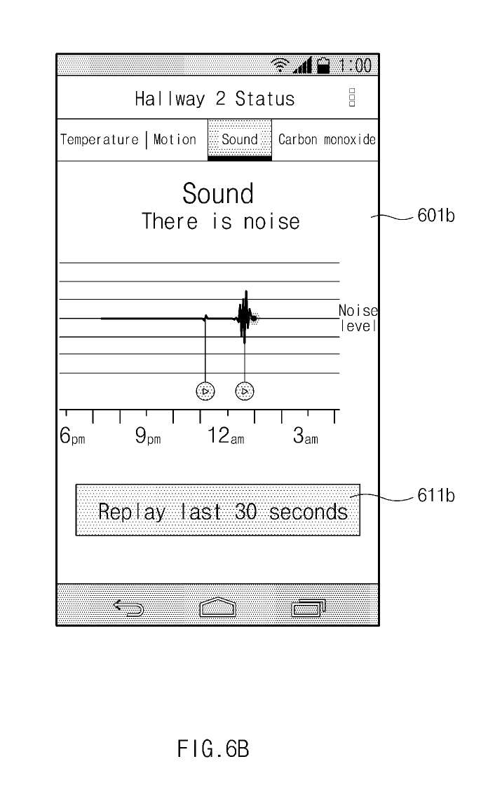

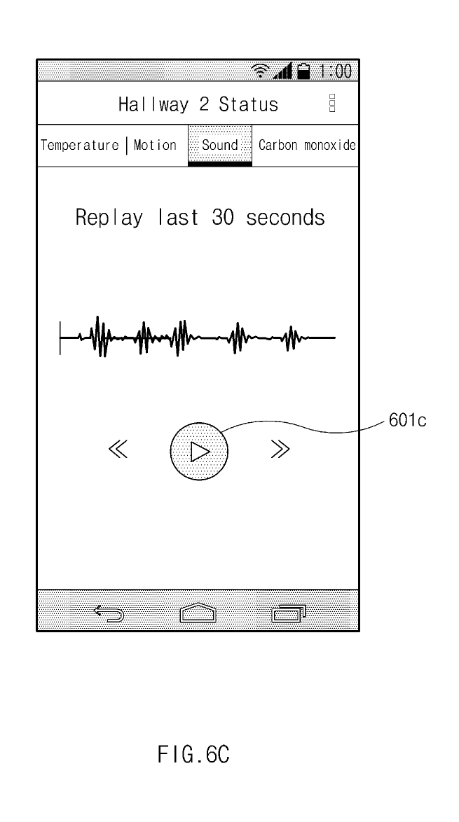

According to an embodiment of the present invention, the mobile terminal 200 replays sensor data sensed by a microphone sensor for a most recent time period if the mobile terminal has determined that an abnormal situation has occurred. A further detailed description replay is provided herein with reference to FIGS. 6A to 6C.

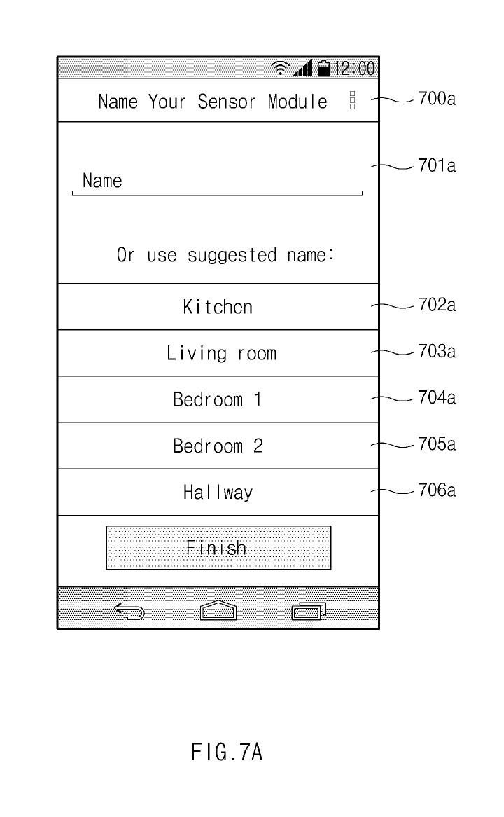

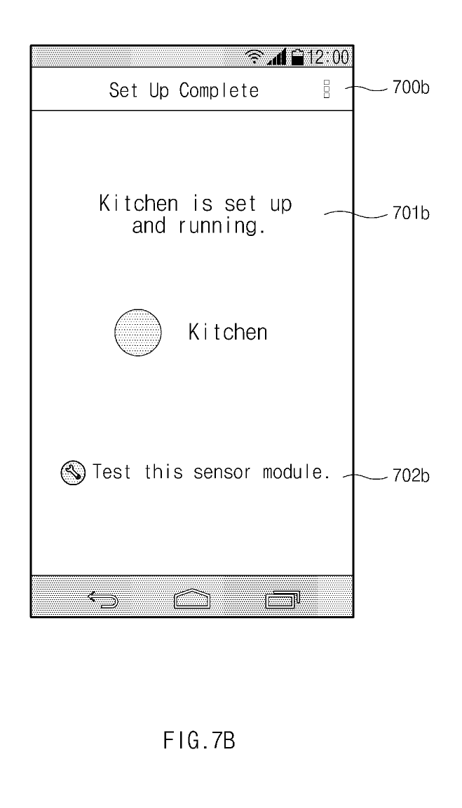

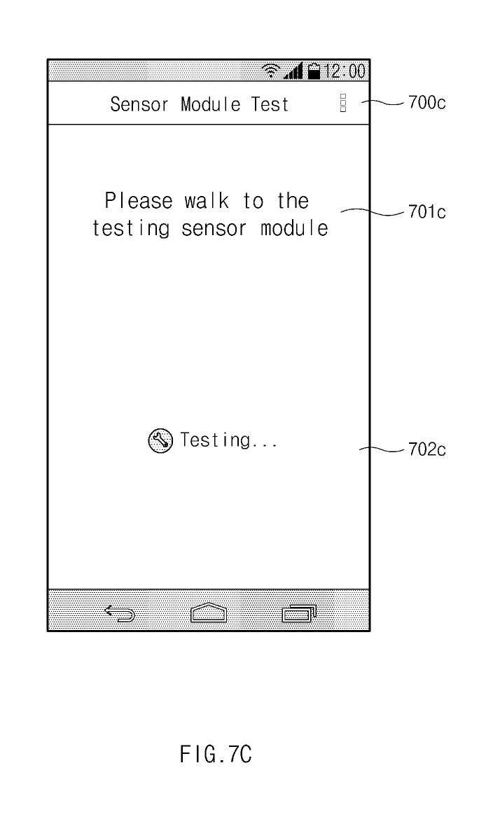

According to an embodiment of the present invention, the mobile terminal 200 calls an emergency center if the mobile terminal 200 determines, as a result of the analysis, that an emergency situation has arisen. A further detailed description of this analysis and the emergency call is provided herein with reference to FIGS. 7A to 7C.

The mobile terminal 200 according to an embodiment of the present embodiment may include, for example, a cellular phone, a smart phone, a laptop computer, a digital broadcasting terminal, a Personal Digital Assistant (PDA), a Portable Multimedia Player (PMP), a navigation device, and a tablet Personal Computer (PC). However, embodiments of the present invention are not limited thereto and may include all portable devices that are able to communicate with the sensor module 100 and analyze a security situation.

FIG. 2 is a diagram illustrating a sensor module according to an embodiment of the present invention.

Referring to FIG. 2, according to an embodiment of the present invention, the sensor module 100 may be a plug-in type as shown on the left hand side of FIG. 2. Thus, the sensor module 100 may be plugged in a wall socket 10 as shown on the right hand side of FIG. 2.

As shown in FIG. 2, a user may put the plug of the sensor module 100 into a socket and thus easily install a security system. A user may pull the plug of the sensor module 100 out of the socket and thus easily remove the sensor module 100. Therefore, it is also possible to move the sensor module 100 and change the security system. Furthermore, it is also easy to expand the security system by installing additional sensor modules 100 in a plurality of spaces.

A user may simply plug the plug-type sensor module 100 having desired-types of sensors into a socket, and thus install a security system according to the user's desires. A user is able to use the mobile terminal 200 to execute the sensor module 100, and thus is able to configure a security system without complex manipulation.

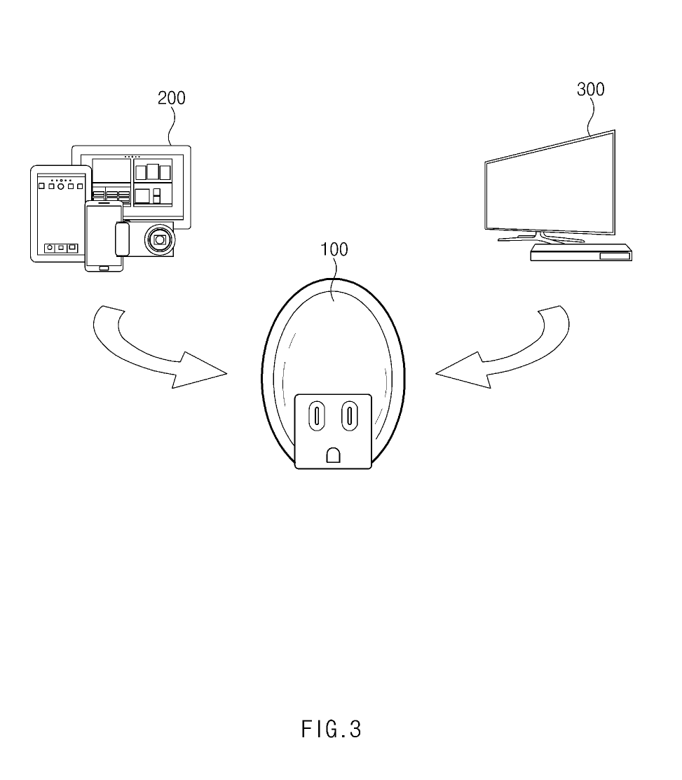

FIG. 3 is a diagram illustrating a security system environment according to an embodiment of the present invention.

Referring to FIG. 3, according to an embodiment of the present invention, a security system that includes at least one sensor module 100 and a mobile terminal 200 can be expanded in conjunction with consumer electronics or communication service devices.

According to an embodiment of the present invention, the mobile terminal 200 integrates sensor data received from the sensor module 100 with information indicating states of consumer electronics 300 received therefrom, and analyzes the security situation of a place such as home or office, based on the integrated information.

For example, the mobile terminal 200 may sense, based on data received from the sensor module 100 plugged in the kitchen, that the temperature and the concentration of CO in a particular location are high. Also, the mobile terminal 200 may also recognize from information indicating the states of the consumer electronics 300 that an oven is in operation. The mobile terminal 200 integrates the received sensor data with the information indicating the states of the consumer electronics 300 and determines that the temperature and the concentration of CO has increased due to the usage of the oven, and therefore, there is no security-related problem regarding the high temperature and high concentration of CO.

According to another example, the mobile terminal 200 may determine, based on data received from the sensor module 100 plugged in a living room, that no motion is sensed, but that a sound is sensed. The mobile terminal 200 may also recognize from information indicating the states of the consumer electronics 300 that a TeleVision (TV) in the living room is operating. Thus, the mobile terminal 200 obtains behavior information indicating that a user is watching the TV in the living room. The mobile terminal 200 integrates the received sensor data with the information on the states of the consumer electronics 300 and in order to determine that the user is watching the TV in the living room and that there is thus no security-related problem.

According to an embodiment of the present invention, the mobile terminal 200 may obtain information regarding the location of a mobile terminal of at least one user through a communication service device. The communication service device is a device that obtains information on the location of at least one user in the place and communicates with the mobile terminal of the at least one user. Thus, the mobile terminal 200 is able to analyze a security situation by additionally using the information regarding the location of the at least one user.

Therefore, if a user enters a certain location, the mobile terminal 200 of the user is able to connect to the communication service device in the place. As such, the communication service device determines, through at least one mobile terminal 200 connecting to the communication service device, whether there is a user in the place as well as determine which user is located in the place, among users whose mobile terminal 200 (or mobile terminals 200) is registered to the security system.

For example, when a security system is installed at a home in which two persons reside, the communication service device is able to sense that the mobile terminal 200 of one of the two persons is being currently connected. The mobile terminal 200 obtains, through the communication service device, location information indicating that one person is in the home and the other is not in the home. Thus, even though a motion sensor or a microphone sensor of the sensor module 100 senses that there is at least one of a motion and a sound in the home, the mobile terminal 200 determines that the motion or the sound is caused by the other person. The mobile terminal 200 integrates received sensor data with location information from the communication service device and determines that there is no security-related problem.

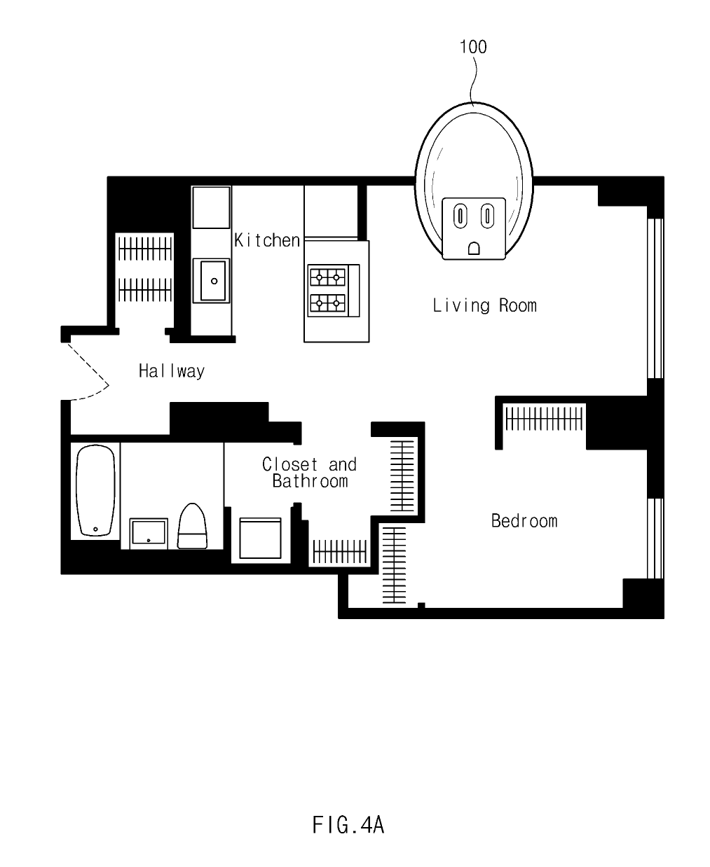

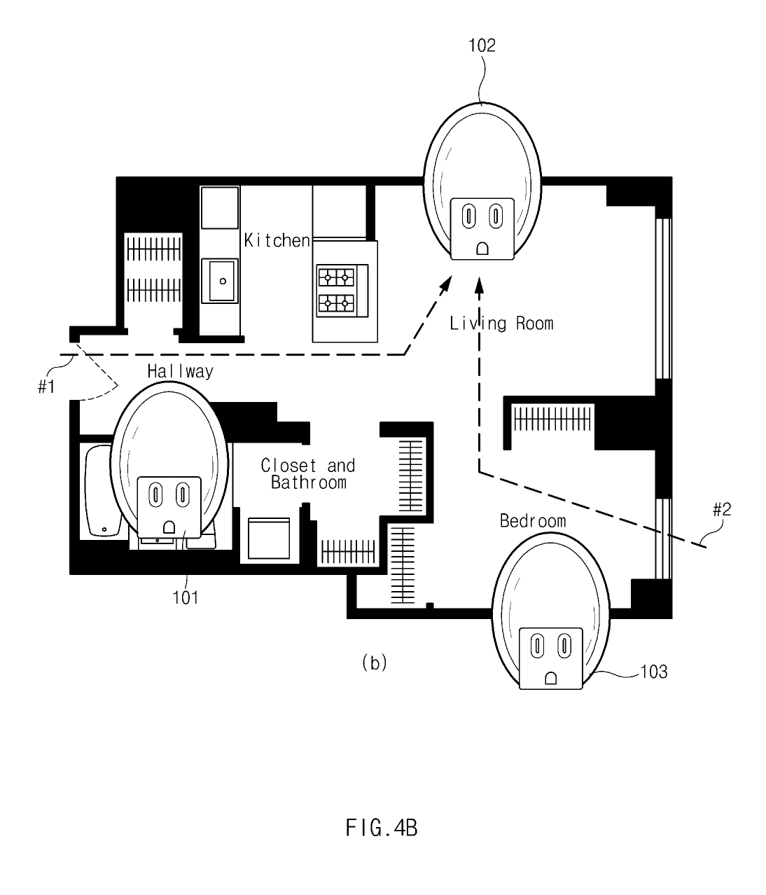

FIGS. 4A and 4B are diagrams illustrating a security system environment according to an embodiment of the present invention.

FIG. 4A is a diagram illustrating a security system of a home in which one sensor module 100 is installed.

Referring to FIG. 4A, the mobile terminal 200 receives sensor data from a plurality of sensors of the sensor module 100 installed in the living room. For example, it is possible to sense a sound and a motion from the living room through sensor data received from the mobile terminal 200. If the mobile terminal 200 has location information of the user indicating that the users are at home, it is possible to determine that the security situation of the home is in a normal state.

Alternatively, it is possible to sense a sound, but not a motion, from the living room, through sensor data received from the mobile terminal 200. In this case, if the mobile terminal 200 has location information of the user indicating that the user is at an outdoor location, the mobile terminal 200 may determine that the security situation of the home is abnormal. Thus, the mobile terminal 200 may inform a user that an abnormal situation has occurred, through a push notification.

FIG. 4B is a diagram illustrating a security system in which a plurality of sensor modules 101 to 103 is installed in several spaces of a home.

Referring to FIG. 4B, according to an embodiment of the present invention, a first sensor module 101, a second sensor module 102, and a third sensor module 103 are plugged in the hallway, living room, and bedroom, respectively. The hallway, living room and bedroom correspond to a first space, a second space and a third space of a home, respectively.

The mobile terminal 200 receives sensor data from a plurality of sensors of each of the first sensor module 100, the second sensor module 101, and the third sensor module 103. The mobile terminal 200 integrates sensor data based on the spatial correlation between pieces of sensor data of the plurality of sensors and analyzes the security situation of the home.

According to an embodiment of the present invention, the mobile terminal 200 obtains the path characteristics of the hallway, living room, and bedroom related to entry or exit of the home and movement in the home, and analyzes a security situation of the home by using the obtained path characteristics. Thus, the mobile terminal 200 determines, from the integrated information, that the location at which a motion has occurred in the home is abnormal in light of the path characteristics, the mobile terminal 200 may determine that the home has a trespasser.

For example, according to the path characteristics of the home shown in FIG. 4B, a door is located near a hallway and thus a motion should start in the hallway when a user is entering the home. If the mobile terminal 200 senses a first motion #1 from the hallway to the living room when there is nobody at home, the mobile terminal determines that the motion corresponds to a normal entrance. However, if the mobile terminal 200 senses a second motion #2 from the bedroom to the living room, the mobile terminal 200 determines that the motion is an abnormal entrance through the bedroom. Accordingly, the mobile terminal 200 may determines that the home has a trespasser.

FIGS. 5A to 5C are diagrams illustrating examples of screens displayed by a mobile terminal while monitoring security situations according to an embodiment of the present invention.

FIG. 5A illustrates a screen (shown as Home Status) displayed by a mobile terminal 200 representing a situation of a home. The mobile terminal 200 provides monitoring of a security situation for each space of the home. More specifically, the mobile terminal 200 provides monitoring of a security situation for each space in which at least one sensor module 100 is located.

As shown in FIG. 5A, the mobile terminal 200 provides monitoring of the security situation of each of a kitchen, a first bedroom 1, a second bedroom, first hallway, and a second hallway. The mobile terminal 200 receives sensor data from sensor modules 100 that are installed in the kitchen, first bedroom, the second bedroom, the first hallway, and the second hallway. The kitchen, the first bedroom, the second bedroom, the first hallway, and the second hallway respectively correspond to a first space 501a, a second space 502a, a third space 503a, a fourth space 504a, and a fifth space 505a of representing places in a home.

If one of the spaces represented in FIG. 5A has an abnormal situation, the mobile terminal 200 displays, in a certain format, information indicating that a corresponding space has an abnormal situation on the Home Status screen.

According to an embodiment of the present invention, the mobile terminal 200 also displays location information and behavior information of the user on the Home Status screen. For example, the mobile terminal 200 may display location information and behavior information of the user on the Home Status screen, such as “You are: Home & Awake”, as shown in space 500a of FIG. 5A.

If a user selects one of the spaces represented in FIG. 5A, the mobile terminal 200 displays the current states of a plurality of sensors of the sensor module 100 installed in the selected space.

FIG. 5B illustrates a screen that represents a plurality of sensors of the sensor module 100 installed in the kitchen.

Referring to FIG. 5B, the mobile terminal 200 monitors the sound, temperature, motion, and CO of the kitchen through the sensor module 100 installed in the kitchen. The sensor module 100 installed in the kitchen includes a microphone sensor, a temperature sensor, a motion sensor, and a CO sensor.

The mobile terminal 200 displays the current state of each sensor in a respective sensor tab. According to an embodiment of the present invention, the mobile terminal 200 provides the current states of sound at space 501, temperature, motion, and CO sensed through the sensor module 100, on the screen (under the heading “Kitchen Status” at space 500b) representing the situation of the kitchen. In the present example, the mobile terminal 200 displays the current states of sound at space, temperature, motion, and CO as “No noise”, “Normal”, “No motion”, and “Normal” at spaces 501b, 502b, 503b, and 504b, respectively, as shown in FIG. 5B. The mobile terminal 200 determines therefrom that no sound or motion is sensed from the kitchen and that the temperature and the concentration of CO are also normal.

When a user selects any sensor included in the sensor module 100, the mobile terminal 200 provides monitoring of sensor data of a selected sensor according to time, as shown in FIG. 5C. The mobile terminal 200 provides, for each space, monitoring of sensor data for each sensor of the sensor module 100 installed in the space.

FIG. 5C illustrates a screen showing sensor data of the temperature sensor of the sensor module 100 installed in the kitchen.

The mobile terminal 200 monitor sensors data of a certain sensor included in the sensor module 100 installed in a certain space according to time. According to an embodiment of the present invention, the mobile terminal 200 enables a user to check, according to time, the details of sensor data through a temperature sensor included in the sensor module 100 installed in the kitchen.

For example, the mobile terminal 200 displays temperature data and the current temperature state according to time, on the Kitchen Status screen, as shown in space 501c FIG. 5C. The mobile terminal 200 also displays the details of sensor data, such as temperature variation in the kitchen according to time.

FIGS. 6A to 6C are diagrams illustrating examples of screens displayed by a mobile terminal when abnormal situations occur according to an embodiment of the present invention.

FIG. 6A illustrates a screen (shown as “Home Status” 600a) representing the situation of a home by the mobile terminal 200.

Referring to FIG. 6A, the mobile terminal 200 displays the security situations of sensor modules 100 installed in the kitchen, the first bedroom, the second bedroom, the first hallway, and the second hallway, respectively, which each correspond to a first space 601a, a second space 602a, a third space 603a, a fourth space 604a, and a fifth space 605a of the home.

If abnormal situations occur in any of the displayed spaces, the mobile terminal 200 indicates that abnormal situations have occurred in corresponding spaces, on the Home Status screen.

According to an embodiment of the present invention, if abnormal situations occur in any of the spaces displayed in FIG. 6A, the mobile terminal 200 displays the abnormal situations in a certain format according to the spaces in which the abnormal situations have occurred. Therefore, the displayed information indicates the spaces in which the abnormal situations have occurred.

According to an embodiment of the present invention, the mobile terminal 200 display information indicating which abnormal situations have occurred on the Home Status screen.

For example, the mobile terminal 200 displays an icon 615a on the location 605a of the second hallway on the Home Status screen and displays the message “There is noise” to notify the user of an abnormal situation that is currently occurring in the second hallway and the details of the abnormal situation, as shown in FIG. 6A.

However, the form of information represented in FIG. 6A is merely provided as an example, and the mobile terminal 200 may display spaces having abnormal situations and the details of the abnormal situations in various other forms in accordance with embodiments of the present invention.

If a user selects one of the spaces having the abnormal situations, the mobile terminal 200 displays the sensor data and current states of sensors having the abnormal situations among a plurality of sensors of the sensor module 100 installed in a selected space.

FIG. 6B illustrates a screen showing sensor data received by a user from a microphone sensor of the sensor module 100 installed in the second hallway.

Referring to FIG. 6B, if a user selects a space in which an abnormal situation has occurred, the mobile terminal 200 provides monitoring of sensor data of a sensor in the selected space according to time.

For example, as shown in FIG. 6B, the mobile terminal 200 displays sound data sensed by a microphone sensor according to time, on the “Hallway 2 Status” screen indicating the situation of the second hallway. Thus, a user is able to check the details of sound data, such as a time at which an abnormal sound has occurred, volume of the abnormal sound, and sound variation according to time.

According to an embodiment of the present invention, the mobile terminal 200 replays a sound sensed by the microphone sensor. For example, the mobile terminal 200 replays a sound obtained by the microphone sensor of the sensor module 100 installed in the second hallway, such as “Replay last 30 seconds” 611b on the “Hallway 2 Status” screen, as shown in FIG. 6B.

FIG. 6C illustrates a screen for replaying a sound sensed by a user through the sensor module 100 installed in the second hallway.

As shown in FIG. 6C, the mobile terminal 200 replays sensor data sensed by the microphone sensor during a most recent time period, if the mobile terminal 200 has determined that an abnormal situation has occurred.

In the present example, the mobile terminal 200 replays the last 30 seconds sound obtained by the microphone sensor of the sensor module 100 installed in the second hallway, such as “Replay last 30 seconds” on the “Hallway 2 Status” screen if a user presses a replay button 601c, as shown in FIG. 6C.

Thus, without going to the second hallway in person, a user is able to check sensor data sensed by the microphone sensor for a most recent time period and take correspondingly appropriate measures.

FIGS. 7A to 7C are diagrams illustrating screens executing and setting a sensor module with a mobile terminal according to an embodiment of the present invention.

FIG. 7A illustrates a screen for setting a name of a sensor module executed by the mobile terminal 200.

Referring to FIG. 7A, if the sensor module 100 is plugged in, the mobile terminal 200 connects to the sensor module 100 by using a communication interface. The mobile terminal 200 receives, from the sensor module 100, information regarding each of a plurality of sensors included in the sensor module 100. Thus, the mobile terminal 200 is able to execute the sensor module 100.

According to an embodiment of the present invention, the mobile terminal 200 uses short-range wireless communication to quickly execute the sensor module 100. Then, the mobile terminal 200 identifies the sensor module 100 and receives set-up information regarding the sensor module 100.

According to an embodiment of the present invention, the mobile terminal 200 requests a user to set-up the name of the identified sensor module 100 and set the name input by the user at input space 701a as the name of the sensor module 100. For example, when the sensor module 100 is installed in a certain space of a home, the mobile terminal 200 may set the name of the sensor module 100 as a name representing a corresponding space, such as “Kitchen” 702a, “Living room” 703a, “Bedroom 1” 704a, “Bedroom 2” 705a, or “Hallway” 706a on the screen (shown under the heading “Name Your Sensor Module” 700a) that sets the name of the sensor module 100, as shown in FIG. 7A.

According to an embodiment of the present invention, the mobile terminal 200 executes or sets up the sensor module through its app. For example, a user may further set the place related characteristics of a place in which an identified sensor module 100 is installed, or the path characteristics of the place, in the mobile terminal 200 by using an app.

FIG. 7B illustrates a screen indicating that the sensor module 100 is set and executed in the mobile terminal 200.

After completing the setup of the sensor module 100 identified by the mobile terminal 200, the mobile terminal 200 displays the setting state and execution state of the sensor module 100. For example, the mobile terminal 200 displays the message “Kitchen is set up and running” 701b on the screen (shown as “Set Up Complete” 700b) shown in FIG. 7B.

After the sensor module 100 is set up in the mobile terminal 200, the mobile terminal 200 provides a test mode in which it is possible to test the operation of the sensor module 100. For example, the mobile terminal 200 may enable a user to enter a test mode by selecting e.g., a “Test this sensor module” region of the screen 702b as shown in FIG. 7B.

FIG. 7C illustrates a screen displayed conducting while conducting a test on a sensor module 100 plugged in the kitchen according to an embodiment of the present invention.

The screen (shown as “Sensor Module Test” 700c) of the sensor module 100 of FIG. 7C displays “Testing . . . ” 702c. In the test mode of the sensor module 100, the mobile terminal 200 may request that a user provide sensor inputs to a plurality of sensors of the sensor module 100.

According to an embodiment of the present invention, the mobile terminal 200 instructs a user to walk to the sensor module 100. In the example of FIG. 7C, the mobile terminal 200 displays “Please walk to the testing sensor module 100” 701c on the Sensor Module Test screen of the sensor module 100.

Through conducting such a test, the mobile terminal 200 is able to inform the user that the mobile terminal 200 is receiving pieces of sensor data included in the sensor module 100 normally.

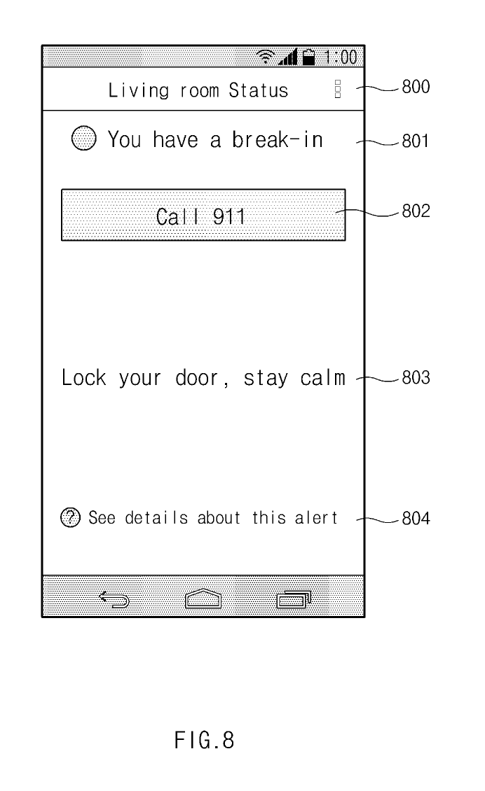

FIG. 8 is a diagram illustrating a screen displayed by a mobile terminal when a break-in occurs according to an embodiment of the present invention.

Referring to FIG. 8, the mobile terminal 200 determines, based on sensor data received from the sensor module 100, that a break-in has occurred in the living room. The mobile terminal 200 informs a user by using an alert or a push notification indicating that the break-in has occurred in the living room.

For example, the mobile terminal 200 displays “You have a break-in” 801 on the screen (shown under the heading “Living room Status” 800) indicating the situation of the living room and informing a user that the break-in has occurred in the living room.

According to an embodiment of the present invention, the mobile terminal 200 may call an emergency center if it is determined, as a result of analyzing the sensors in the house, that an emergency situation such as a break-in has occurred. For example, the mobile terminal 200 may display “Call 911” 802 as shown in FIG. 8 and call the emergency center.

According to an embodiment of the present invention, the mobile terminal 200 provides detailed behavior guidelines so that a user is not embarrassed and does not make a mistake, if the user experiences a break-in. In the example of FIG. 8, the mobile terminal 200 provides behavior guidelines such as “Lock your door, stay calm” 803.

According to an embodiment of the present invention, the mobile terminal 200 informs a user of a break-in and then provides monitoring of sensor data of a plurality of sensors of at least one sensor module 100 related to the break-in. In the example of FIG. 8, the mobile terminal 200 provides a link to sensor data such as “See details about this alert” 804.

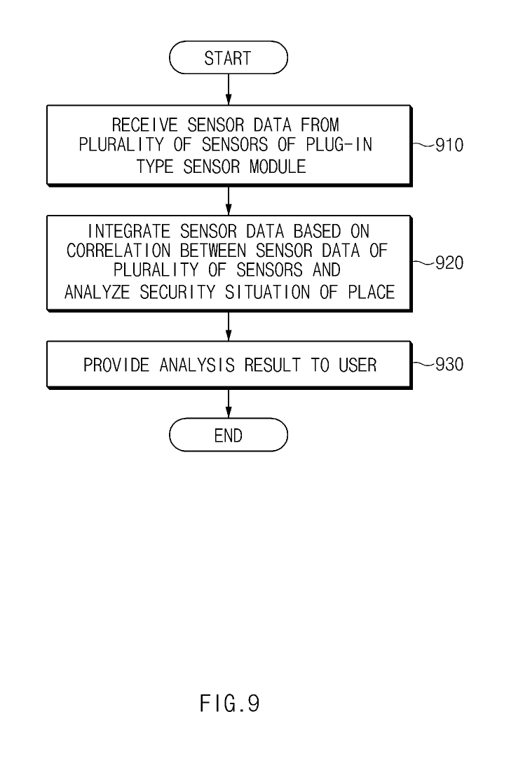

FIG. 9 is a flowchart illustrating a method of providing a security service according to an embodiment of the present invention. The flowchart shown in FIG. 9 includes processes processed in a time-series manner by the security system shown in FIGS. 1 to 8. Thus, descriptions provided above with respect to the security system shown in FIGS. 1 to 8 may also be applied to the flow chart shown in FIG. 9 in accordance with embodiments of the present invention, even when not specifically mentioned below.

Referring to FIG. 9, in step 910, the mobile terminal 200 receives sensor data from a plurality of sensors of a plug-in type sensor module 100.

In step 920, the mobile terminal 200 integrates sensor data based on the correlation between pieces of sensor data of the plurality of sensors and analyzes the security situation of place where the sensor module is plugged-in.

In step 930, the mobile terminal 200 provides an analysis result to a user.

According to an embodiment of the present invention, the mobile terminal 200 provides the details of sensor data if the mobile terminal 200 determines that an abnormal situation has occurred.

According to an embodiment of the present invention, the mobile terminal 200 replays sensor data sensed by a microphone sensor for a most recent time period if the mobile terminal 200 determines that an abnormal situation has occurred.

According to an embodiment of the present invention, the mobile terminal 200 provides a push notification alerting a user if the mobile terminal 200 determines that an abnormal situation has occurred.

According to an embodiment of the present invention, the mobile terminal 200 calls an emergency center if the mobile terminal 200 determines that an emergency situation has occurred.

According to an embodiment of the present invention, the mobile terminal 200 obtains location information of a user and analyzes a security situation of a location by also using the location information of the mobile terminal 200.

According to an embodiment of the present invention, the mobile terminal 200 also obtains place-related characteristics of a place in which the sensor module 100 is installed, and in step 930, the mobile terminal 200 analyzes a security situation of the place by also using the place-related characteristics of the place in which the sensor module 100 is located.

According to an embodiment of the present invention, the mobile terminal 200 obtains behavior information of the user and, in step 930, the mobile terminal 200 analyzes a security situation by also using behavior information of the user.

According to an embodiment of the present invention, the mobile terminal 200 further includes (or is connected to) at least one plug-in sensor module. Thus, in step 910, the mobile terminal 200 receives sensor data from a plurality of sensors of a plurality of sensor modules 100. In step 930, based on the spaces within the place in which the plurality of sensor modules are plugged-in, the mobile terminal 200 analyzes the overall security situation of the place, by also using the spatial correlation between pieces of sensor data of the plurality of sensors of the plurality of sensor modules.

According to an embodiment of the present invention, the mobile terminal 200 also obtains the path characteristics between spaces within the place in which the plurality of sensor modules are plugged-in, and in step 930, the mobile terminal 200 analyzes a security situation by also using the path characteristics.

According to an embodiment of the present invention, the mobile terminal 200 also provides monitoring of a security situation for each space in which each of the plurality of sensor modules are located, and also provide monitoring of sensor data of each sensor of the plurality of sensor modules.

According to an embodiment of the present invention, the mobile terminal 200 uses short-range wireless communication to connect to the sensor module 100, receives information on the plurality of sensors included in the sensor module 10, and executes the sensor module. The mobile terminal 200 also receives an input of setup information on the sensor module 100 and sets up the sensor module 100 on the mobile terminal 200 based on the input information.

According to an embodiment of the present invention, the mobile terminal 200 also provides a test mode in which it is possible to test the operations of the sensor module 100.

Methods according to embodiments of the present invention may be rendered as a program executable on a computer, and may be implemented in a general-purpose digital computer that executes the program by using a computer readable recording medium. Examples of the computer readable recording medium include magnetic storage media (e.g., Read Only Memory (ROM), floppy disks, hard disks, etc.) and optical recording media (e.g., Compact Disc (CD)-ROMs, or Digital Versatile Discs (DVDs)).

The security systems and the methods of providing a security service according to embodiments of the present invention are able to use a synergy effect between the plurality of sensors included in the sensor module to determine the current security situation by using various pieces of sensor data and provide accurate security information.

By using a mobile terminal and a plug-in type sensor module that is easily installed and removed, it is possible to move and change a security system without extra costs, and provide a cost-effective security system in which a security system may be easily expanded.

All the embodiments and conditional examples disclosed herein are described to help a person skilled in the art to understand the principles and concepts of the present invention. It will be understood by a person skill in the art that various changes in form and details may be made therein without departing from the spirit and scope of the present invention. Therefore, the disclosed embodiments should be considered in a descriptive sense only and not for purposes of limitation. The scope of the invention is defined not by the detailed description of the invention but by the appended claims, and all differences within the scope will be construed as being included in the present invention.

What is claimed is:

1. A security system comprising:
a first plug-in type sensor module including a plurality of sensors; and
a first mobile terminal configured to:
receive sensor data from the plurality of sensors included in the first plug-in type sensor module,
integrate the sensor data based on a correlation between sensor data of the plurality of sensors to generate integrated information,
analyze, based on the integrated information, a security situation of a place into which the first plug-in type sensor module is plugged, and
provide a result of the analysis to a user.

2. The security system according to claim 1, wherein the first mobile terminal is further configured to obtain information of a location of the first mobile terminal, and
wherein the first mobile terminal analyzes the security situation based on the integrated information and the location information.

3. The security system according to claim 2, wherein the plurality of sensors include a motion sensor and a microphone sensor, and
wherein analyzing the security situation of the place includes determining, when it is determined from the integrated information and the location information that at least one of a motion and a sound has occurred in the place while the user is not located the place, that a trespasser is in the place.

4. The security system according to claim 1, wherein the first mobile terminal is further configured obtain a place-related characteristic of the place other than the sensor data of the plurality of sensors, and
wherein the first mobile terminal analyzes the security situation based on the integrated information and the place-related characteristic.

5. The security system according to claim 4, wherein the plurality of sensors include a temperature sensor and a carbon monoxide (CO) sensor, and
wherein analyzing the security situation of the place includes determining, when it is determined from the integrated information and the place-related characteristics that at least one of a temperature and a concentration of CO of the place is at least equal to a certain value and the place-related characteristic of the place does not representing a cooking-related place, that a fire has occurred in the place.

6. The security system according to claim 1, wherein the first mobile terminal is further configured to obtain behavior information of the user, and
wherein the first mobile terminal analyzes the security situation based on the integrated information and the behavior information.

7. The security system according to claim 6, wherein the plurality of sensors include a motion sensor and a microphone sensor, and
wherein analyzing the security situation of the place includes determining, when it is determined from the integrated information and the behavior information that at least one of a motion and a sound has occurred in the place while the user is sleeping, that a trespasser is in the place.

8. The security system according to claim 1, further comprising a second plug-in type sensor module,
wherein the first plug-in type sensor module is plugged into a first space of the place and the second plug-in type sensor module is plugged into a second space of the place,
wherein the first mobile terminal is further configured to receive sensor data from a plurality of sensors of the second plug-in type sensor module, and
wherein integrating the sensor data received from the plurality of sensors included in the first plug-in type sensor module includes integrating the sensor data received from the plurality of sensors of the first plug-in type sensor module and the sensor data received from the plurality of sensors of the second plug-in type sensor module based on a spatial correlation between pieces of sensor data of the plurality of sensors of each of the first plug-in type sensor module and the second plug-in type sensor module.

9. The security system according to claim 8, wherein the first mobile terminal is further configured to obtain a characteristic of a path between the first space and the second space related to at least one of entry into the place, exit from the place, and movement within the place, and
wherein the first mobile terminal analyzes the security situation based on the integrated information and the path characteristic.

10. The security system according to claim 9, wherein the plurality of sensors of each of the first plug-in type sensor module and the second plug-in type sensor module include a motion sensor, and
wherein analyzing the security situation of the place includes determining, when it is determined from the integrated information and the path characteristic that a location of the place at which a motion is sensed is abnormal, that a trespasser is in the place.

11. The security system according to claim 1, wherein providing the result of the analysis to the user includes providing details of the sensor data when the result of the analysis indicates that an abnormal situation has occurred.

12. The security system according to claim 1, wherein the plurality of sensors include a microphone sensor, and
wherein providing the result of the analysis to the user includes replaying sensor data sensed by the microphone sensor for a most recent time period when a result of the analysis indicates that an abnormal situation has occurred.

13. The security system according to claim 1, wherein providing the result of the analysis to the user includes providing an alerting push notification to the user when the result of the analysis indicates that an abnormal situation has occurred.

14. The security system according to claim 1, wherein the first mobile terminal is further configured to call an emergency center when the result of the analysis indicates that an emergency situation has occurred.

15. The security system according to claim 1, wherein when the first plug-in type sensor module is plugged in the place, the first mobile terminal uses short-range wireless communication to execute the first plug-in type sensor module and provides the result of the analysis to the user through an app of the first mobile terminal.

16. The security system according to claim 1, further comprising an additional sensor module,
wherein the first plug-in type sensor module is plugged into a first space of the place and the additional sensor module is located in a second space of the place,
wherein the first mobile terminal is further configured to receive sensor data from a plurality of sensors of the additional sensor module, and
wherein integrating the sensor data received from the plurality of sensors included in the first plug-in type sensor module includes integrating the sensor data received from the plurality of sensors of the first plug-in type sensor module and the sensor data received from the plurality of sensors of the additional sensor module.

17. The security system according to claim 1, wherein the first mobile terminal is further configured to provide, when the first plug-in type sensor module is executed, the first mobile terminal, a test mode in which operation of the first plug-in type sensor module is tested.

18. The security system according to claim 1, further comprising a communication service device in the place configured to obtain, from a second mobile terminal, location information of a user of the second mobile terminal,
wherein the first mobile terminal is further configured to obtains the location information of the user of the second mobile terminal from the communication service device, and
the first mobile terminal analyzes the security situation by based on the integrated information and the location information of the user of the second mobile terminal.

19. The security system according to claim 1, wherein the plurality of sensors includes at least one of a motion sensor, a microphone sensor, a temperature sensor, an illumination sensor and a CO sensor.

20. A method of providing a security service comprising:
receiving, by a mobile terminal, sensor data from a plurality of sensors included in a first plug-in type sensor module;
integrating, by the mobile terminal, the sensor data based on a correlation between pieces of sensor data of the plurality of sensors to generate integrated information;
analyzing, based on the integration information, a security situation of a place into which the first plug-in type sensor module is plugged; and
providing, by the mobile terminal, a result of the analysis to a user.
